(19) United States
(12) Patent Application Publication
(10) Pub. No.: US 2003/0005023 A1
(43) Pub. Date: Jan. 2, 2003

(54) Batch access method and system

(76) Inventors: John Gilbert, Austin, TX (US); Dave Hawkins, Austin, TX (US)

Correspondence Address: Steven R. Greenfield, Esq., Jenkens & Gilchrist, P.C., 1445 Ross Avenue, Suite 3200, Dallas, TX, 75202-2799, US

(21) Appl. No.: 09/872,387

(22) Filed: Jun. 1, 2001

(51) Int. Cl. G06F 15/16

(52) U.S. Cl. 709/101; 709/250; 709/217

(57) ABSTRACT

Method and system of managing a plurality of communication devices are disclosed for maximizing the success rate of data access jobs performed thereon and to optimize the usage efficiency of the communication devices. An exemplary system includes a plurality of data access jobs that are placed in a queue. Each data access job in the queue is assigned to one of a plurality of communication devices. The assignments are made based on the availability of the communication devices. No data access job is permanently assigned to any communication device. Once a data access job is completed, the communication device is released and then can be reassigned to another data access job. Script files are generated for each data access job to control the operation of the communication devices. The progress of the data access jobs are logged. Unsuccessful data access jobs are aborted and rescheduled or otherwise permanently or temporarily canceled. Data related to the failure modes for unsuccessful jobs are captured and statistically compiled to observe any trends arising therefrom. The communication devices are graded and scored based on successful and failed jobs and failure modes of the communication data. Once a communication device attains a predetermined score, it is temporarily or permanently taken off-line.

### BACKGROUND OF THE INVENTION

1. Field of the Invention

The present invention relates generally to batch access systems and, more particularly, to a method and system for managing a plurality of communication devices.

2. Description of the Related Art

The tremendous popularity of the Internet has given rise to a host of B-commerce type applications including a number of on-line shopping or E-marketplace applications. In a typical B-marketplace application, vendors of the same or similar products and services provide information therefor to a searchable on-line database. This information is then made available to on-line users via a search engine associated with the database. To shop on-line, a user simply connects by way of the Internet to an appropriate one of the databases for a particular product or service and searches therein using the associated search engine. The user may thereafter place an order for the desired product or service on-line, or purchase the same by going directly to the vendor thereof. Such an arrangement allows a vendor to make its products and services available to a far greater number of potential customers than it heretofore could.

Because there are theoretically no geographical limits on-line, E-marketplace applications often involve vendors located throughout a very large geographical region or possibly an entire country or several countries. Consequently, the number of vendors engaged in a particular E-marketplace application may be very substantial, often in the hundreds or even thousands. The large number of vendors presents a challenge for operators of the searchable on-line databases to be able to obtain and update product information from every vendor accurately and at a sufficiently frequent rate.

Prior methods of obtaining data involve using a dedicated desktop computer having a single modem connected thereto to access a telephone network and, in turn, the vendor systems in order to obtain product and service information. Referring to FIG. 1, a plurality of vendor systems 10a-i are shown, each vendor system representing one or more of the numerous vendors of a particular product or service being offered on a searchable on-line database. A plurality of dedicated desktop computers 12a-c, each one having a communication device 14a-c connected thereto, respectively, are used to access the vendor systems 10a-i via a telephone system 16 and obtain data therefrom. The communication devices 14a-c are usually analog modems that dial in to the vendor systems 10a-i over regular public telephone lines 18. Script files running on each one of the desktop computers 12a-c control the communication devices 14a-c to facilitate access to the vendor systems 10a-i.

Because there are many more vendor systems 10a-i than there are desktop computers 12a-c, it is necessary to divide the list of vendor systems amongst the available desktop computers. In the example of FIG. 1, the first desktop computer 12a has been assigned to access the first three vendor systems 10a-c; while the second desktop computer 12b has been assigned to access the fourth, fifth, and sixth vendor system 10d-f; and the third desktop computer 12c has been assigned to access the last three vendor systems 10g-i. The desktop computers 10a-c are then programmed according to some predetermined schedule to access the vendor systems 10a-i on their respective lists, one vendor system at a time. The accesses usually occur at night time when the vendor systems are considered to be less busy or less congested with data traffic. Typically, each access session, called a “job”, must be successfully completed in its turn before the next access job is attempted. An unsuccessful access job is repeated for a predetermined number of times before moving on to the next access job.

Such previous methods were not efficient, however, because one unsuccessful access job greatly delayed or disabled the other access jobs on the list. Moreover, if either a communication device 14a-c or the desktop computer 12a-c connected thereto became disabled, none of the access jobs assigned to that desktop computer would be completed. These incomplete access jobs would have to be rerun the next day, thereby preventing that desktop computer or another desktop computer from being used for other purposes. Furthermore, such previous methods were inflexible in that new desktop computers would have to be added each time the number of vendor systems increased beyond the incremental capacity of the existing desktop computers.

Therefore, it is desirable to be able to provide a way to reduce the inefficiency and inflexibility associated with the previous methods. More specifically, it is desirable to be able to manage a plurality of communication devices in such a way so as to maximize the success rate of the data access jobs performed thereon and to optimize the usage efficiency of the communication devices.

### SUMMARY OF THE INVENTION

The present invention is related to a method and system for managing a plurality of communication devices so as to maximize the success rate of data access jobs performed thereon and to optimize the usage efficiency of the communication devices.

An exemplary system includes a plurality of data access jobs that are placed in a queue. Each data access job in the queue is assigned to one of a plurality of communication devices. The assignments are made based on the availability of the communication devices. No data access job is permanently assigned to any communication device. Once a data access job is completed, the communication device is released and then can be reassigned to another data access job. Script files are generated for each data access job to control the operation of the communication devices. The progress of the data access jobs are logged. Unsuccessful data access jobs are aborted and rescheduled or otherwise permanently or temporarily canceled. Data related to the failure modes for unsuccessful jobs are captured and statistically compiled to observe any trends arising therefrom. The communication devices are graded and scored based on successful and failed jobs and failure modes of the communication data. Once a communication device attains a predetermined score, it is temporarily or permanently taken off-line.

In one aspect, the invention is related to a method of managing a plurality of communication devices. The method comprises the steps of forming a queue of data access jobs to be run on the plurality of communication devices, executing the data access jobs in accordance with the queue, and controlling the queue in order to optimize a usage efficiency of the plurality of communication devices.

In another aspect, the invention is related to a system for managing a plurality of data access jobs. The system comprises a plurality of communication devices for performing the plurality of data access jobs, a local control unit coupled to and configured to operate the plurality of communication devices in accordance with a queue, and a system control unit in communication with the local control unit and configured to control the queue in order to optimize a success rate of the data access jobs.

In yet another aspect, the invention is related to a method of managing a plurality of communication devices. The method comprises the steps of forming a queue of data access jobs to be run on the plurality of communication devices and executing the data access jobs in accordance with the queue. The queue is controlled in order to optimize a success rate of the data access jobs, and such control is accomplished using the Internet. Failure data are compiled for unsuccessful data access jobs and a score is assigned to one or more of the plurality of communication devices based on the failure data. Communication devices that score above a predetermined score are taken off-line. The progress of one or more of the data access jobs is logged, and manual control of a data access job is allowed via an Internet connection upon user request.

### BRIEF DESCRIPTION OF THE DRAWINGS

A more complete understanding of the method and apparatus of the present invention may be had by reference to the following detailed description when taken in conjunction with the accompanying drawings wherein:

FIG. 1 illustrates a prior art method of obtaining data from a plurality of data systems;

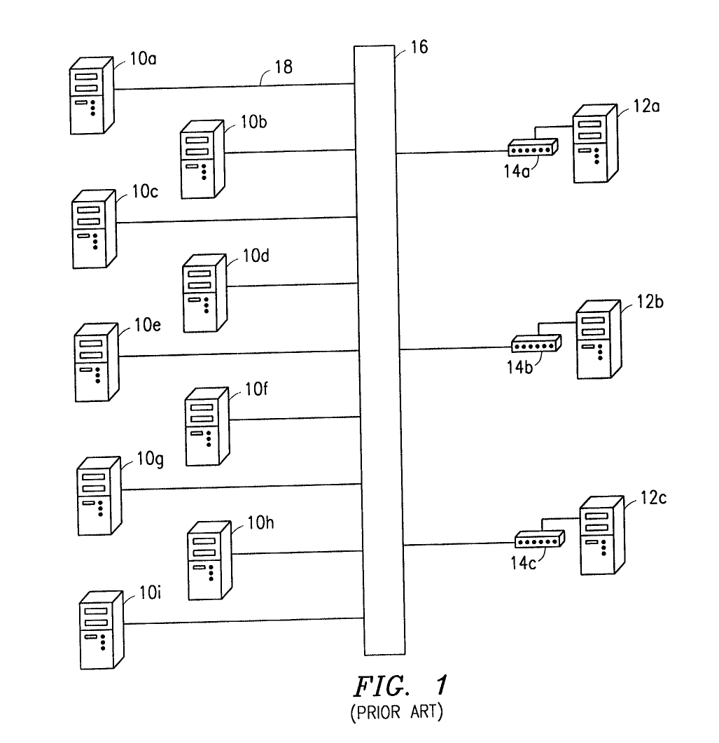

FIG. 2 illustrates an exemplary communication device pool according to an embodiment of the present invention;

FIG. 3 illustrates an exemplary data access job queue according to an embodiment of the present invention;

FIG. 4 illustrates an exemplary network of communication device pools according to an embodiment of the present invention;

FIG. 5 illustrates the functional components of an exemplary system control unit according to an embodiment of the present invention;

FIG. 6 illustrates an exemplary batch access management program according to an embodiment of the present invention;

FIGS. 7A-C illustrate exemplary screen shots of the exemplary batch access management program in FIG. 6; and

FIG. 8 illustrates an exemplary batch access management method according to an embodiment of the present invention.

### DETAILED DESCRIPTION OF THE PREFERRED EMBODIMENTS

As mentioned previously, the present invention places data access jobs in a queue and assigns these data access jobs to a plurality of communication devices. The with assignments are made based on the availability of the communication devices so that no communication device is permanently assigned to carry out a particular one or set of data access jobs. Such an arrangement has an advantage in that the failure of one communication device will not unduly delay execution of the remaining data access jobs. Furthermore, resources are better utilized with the present invention because there is little or no idle time for the communication devices between jobs. Moreover, new data access jobs may simply be added to the queue without requiring additional communication devices and any hardware associated therewith to be purchased. Also, malfunctioning communication devices are taken off-line to increase the success rate of the pending data access jobs.

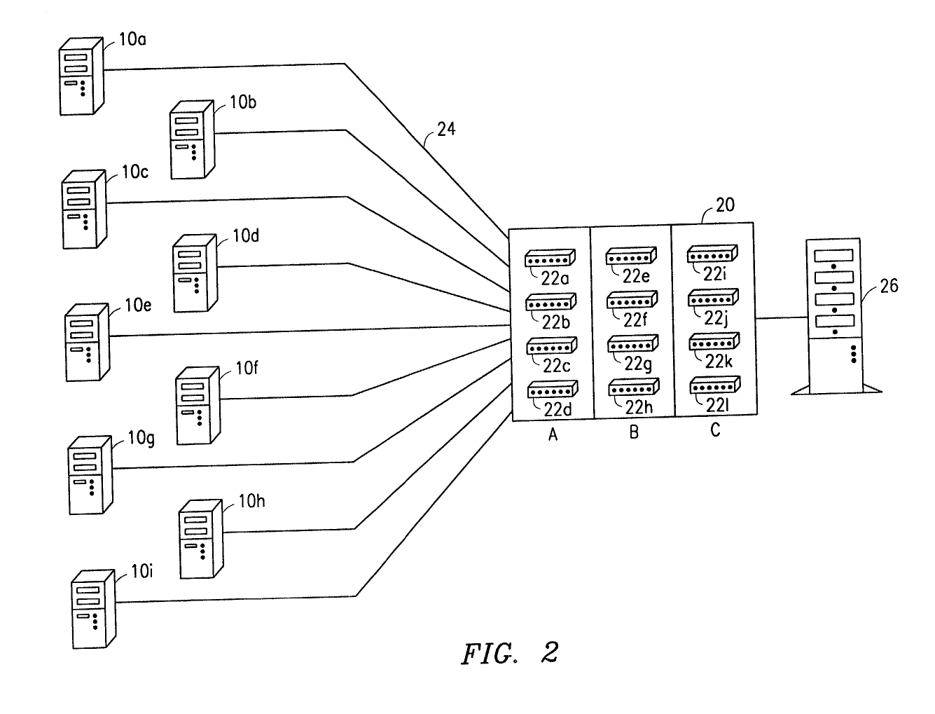

Referring now to FIG. 2, in an exemplary embodiment of the present invention, the plurality of desktop computers described previously has been replaced by a communication device pool 20 formed by a plurality of communication devices 22a-l arranged therein. The communication devices 22a-l may be comprised of any communication device capable of making an on-line connection including analog modems, digital modems, network interface cards, or some combination thereof. Each of the communication devices 22a-l may be operated independently of the other communication devices and preferably has a separate access line 24 connected thereto. The access lines 24 may be comprised of any communication lines suitable for use with the communication devices 22a-l including public telephone lines, private subscriber lines (e.g., ISDN), a wireless transmission link, or some combination thereof.

Only twelve communication devices 22a-l have been included in the communication device pool 20 here for economy of the description and the drawings; however, the invention is not to be limited thereto and those of ordinary skill in the art will understand that a greater or lesser number of communication devices 22a-l may certainly be used. Also, for convenient reference, the communication device pool 20 has been divided into three banks of four communication devices each, with bank A having the first four communication devices, bank B having the second four communication devices, and bank C having the last four communication devices.

A local control unit 26 is coupled to the communication device pool 20 for controlling the operation of the communication devices 22a-l therein. In a preferred embodiment, the local control unit 26 is a high-end computer such as a workstation or a server that is capable of exercising virtually simultaneous control over each one of the independently operable communication devices 22a-l. The particular hardware and software needed to connect the communication device pool 20 to the local control unit 26 are well known and will not be described here.

In operation, script files are executed by the local control unit 26 to automate access to the vendor systems 10 by the communication devices 22a-l. Such script files are generally well known to those of ordinary skill in the art as being useful in providing the commands and controls for the various functions of the communication devices 22. In a preferred embodiment, a script file is set up for each data access job and customized for a particular vendor system. For example, in the case of a modem, a script file can provide the dial-in number including any area code required, the login sequence including any user ID and/or password required, and the appropriate commands for extracting the subject data from the vendor system.

In addition to direct dial, script files may also be set up for other access methods such as for a virtual network. Connection to the vendor systems and the transfer of data therefrom may be accomplished using protocols such as Telnet, FTP, Kermit, and any other suitable communication protocols.

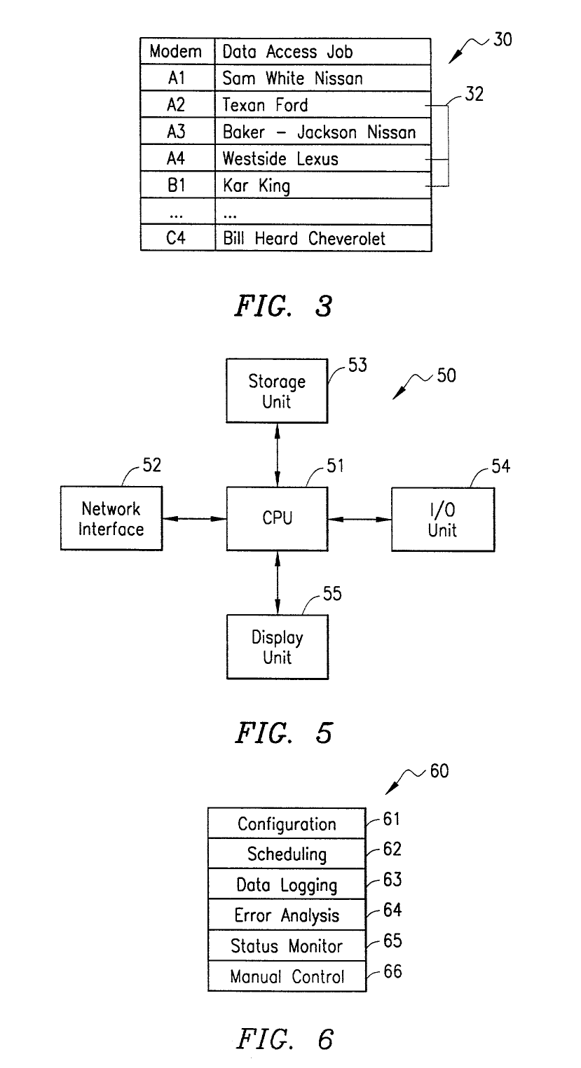

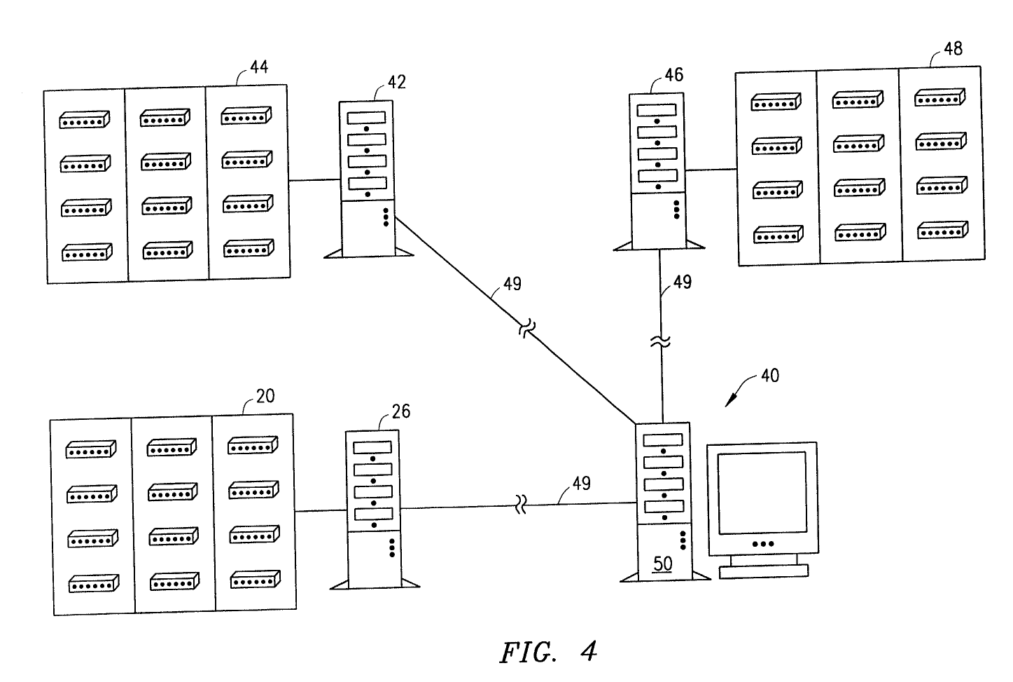

The sequence or order in which the data access jobs are executed, as well as the communication devices 22a-l that will be executing the data access jobs, are specified by a queue stored on the local control unit 26. FIG. 3 illustrates an exemplary data access job queue 30 according to one embodiment of the present invention. As can be seen, the data access job queue 30 is comprised of one or more data access jobs 32 that are to be executed via the local control unit 26. The order of execution is usually one job at a time starting at the top of the queue 30, but in some embodiments the data access jobs 32 may be executed starting from the bottom of the queue 30 instead. The queue 30 itself, that is to say, the order of the data access jobs therein, is determined by a main system control unit 40, as shown in FIG. 4. As can be seen, the system control unit 40 is connected to the local control unit 26 described above as well as a second local control unit 42 and a third local control unit 46. The second and third local control units 42 and 46 are coupled to a second and third communication device pool 44 and 48, respectively, and are similar in construction and operation to the first local control unit 26. Together, the system control unit 40 and the local control units 26, 42, and 46 form a network of communication device pools. In operation, the local control units 26, 42, and 46 query the system control unit 40 for pending data access jobs to executed, and the system control unit 40 assigns the data access jobs according to their positions in the queue 30 to the available communication devices of the local control units 26, 42, and 46.

A plurality of access lines 49 connect the system control unit 40 to the local control units 26, 42, and 46. As before, the access lines may be any communication lines suitable for connecting the system control unit 40 to the local control units 26, 42, and 46. However, in the preferred embodiment, each one of the access lines 49 represents one or more links that form a connection between the system control unit and the local control units across the Internet. Thus, in this embodiment, the system control unit 40 can conveniently and efficiently control the local control units 26, 42, and 46 from virtually anywhere using the Internet. Such an arrangement allows the local control units 26, 42, and 46 to be located almost anywhere in the world provided they can be connected to the Internet.

Each of the first, second, and third control units 26, 42, and 46 and their respective communication device pools 20, 44, and 48 preferably serve vendors located in a different geographic region, country, or even several countries. Note that although only three communication device pools are shown here, the invention should not be limited thereto and those of ordinary skill in the art will understand that a lesser or greater number of communication device pools may certainly be used.

The system control unit 40, like the local control units 26, 42, 46, may include one or more high-end computers such as a workstation or a server. In a preferred embodiment, the system control unit 40 includes a Web server 50. In general, a Web server is a type of server that is capable of hosting a Web site thereon. Thus, a user having the appropriate security authorization (if required) may connect to the Web site using any one of several commercially available Web browsers by opening the URL of the Web site.

Operation of the server 50 may be controlled by any one of several presently available software operating systems such as Windows (TM), Linux (TM), or Unix (TM). The choice of which operating system to run may depend, in part, on which operating system is being used by the vendor systems. For example, if the majority of the vendor systems are using Unix (TM) or a Unix-based operating system, it may be preferable to choose an operating system like Linux (TM) that is not only considered to be reliable, but is compatible with Unix (TM) and has Unix-like features such as Telnet that allows a user to manually access the vendor systems.

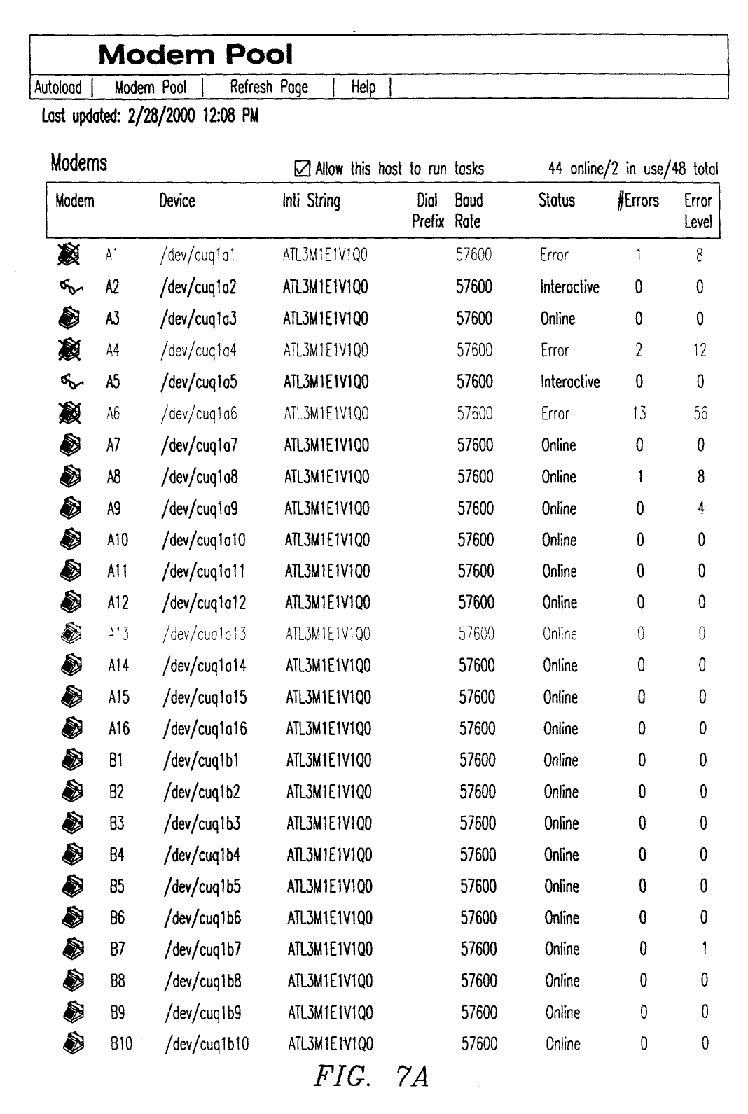

FIG. 5 illustrates some of the functional components of the server 50 of the system control unit 40. Specifically, the server 50 includes a central processing unit 51, a network interface 52, a data storage unit 53, an I/O unit 54, and a display unit 55, all interconnected as shown. During operation, the central processing unit 51 is primarily responsible for executing the various software programs that may be running on the server 50 including the server operating system. The network interface 52 is primarily responsible for connecting the server 50 to the on-line domain in general and specifically to the Internet. The data storage unit 53 provides storage for any data and software programs needed by the server 50. The I/O unit 54 is primarily responsible for inputting data to and outputting data from the server 50 and includes one or more I/O ports for interfacing with, e.g., a keyboard, mouse, floppy disk drive, CD-ROM, and the like. Finally, the display unit 38 is responsible for displaying any visual graphics or images from the server 50.

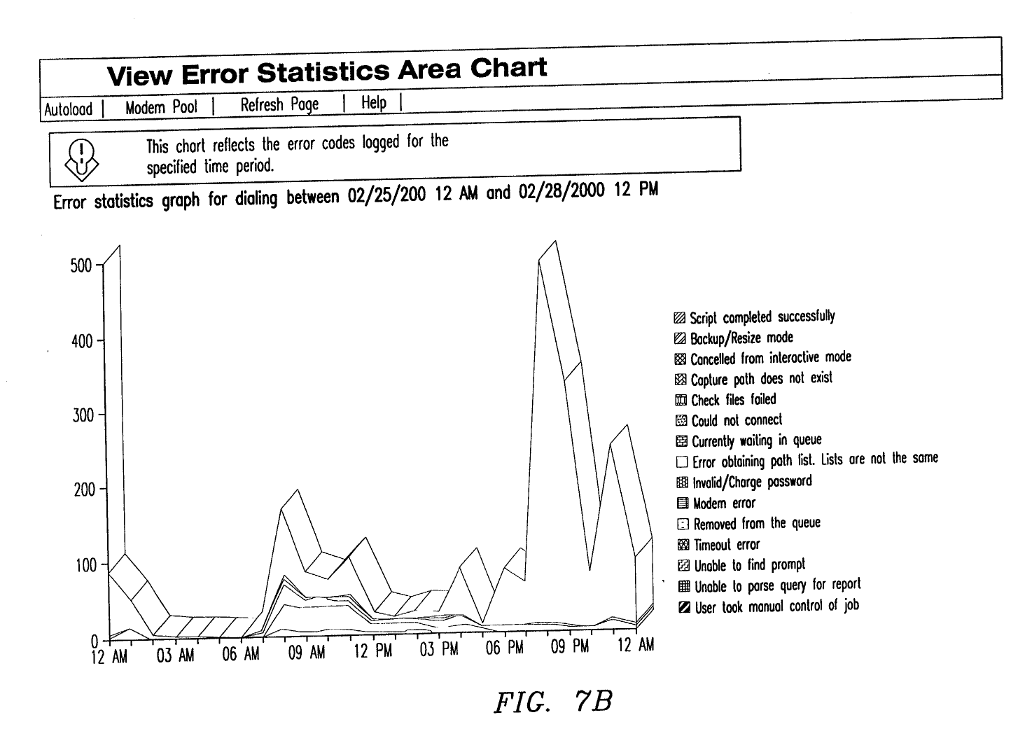

One of the software programs stored in the storage unit 53 and executed by the central processing unit 51 of the server 50 is a batch access management program 60 for managing a plurality of data access jobs, as illustrated in FIG. 6. In general, the batch access management program 60 of the system control unit 40 organizes a plurality of data access jobs into one or more queues, assigns the data access jobs to the available communication devices in the communication device pools, and provides these queues to the local control units of the communication device pools to be executed. The local control units thereafter provide feedback on the progress of each data access job to the system control unit 40. The batch access management program 60 may then modify the queues as needed depending on the successful completion of the data access jobs as well as other information provided by the local control units.

In a preferred embodiment, the batch access management program 60 is a Web-based application that can be executed in a Web browser environment. As such, the batch access management program 60 may be run from within any commercially available Web browser by clicking on the appropriate link in the Web site hosted by the server 50. Such an arrangement has an advantage in that the batch access management program 60 may be accessed from virtually any location that can be connected to the Internet provided, of course, the user has the appropriate security authorization.

Referring now to FIG. 6, the functional components of the batch access management program 60 generally include a configuration module 61, a scheduling module 62, a data logging module 63, a status monitor module 64, an error detection module 65, and a manual control module 66. Following is a short description of the operation of each module.

The configuration module 61 allows a user to set up and otherwise configure the various communication devices. For example, in the case of a modem, the configuration module 61 allows a user to specify the modem initialization string, baud rate, dialing prefix, and other properties of the modem. Alternatively, a modem may be automatically detected by the local control unit by virtue of a plug-n-play feature of the modem. In that case, the configuration module 61 can automatically set up the modem using the information provided by the local control unit. Other types of communication devices may be set up and configured in a similar manner.

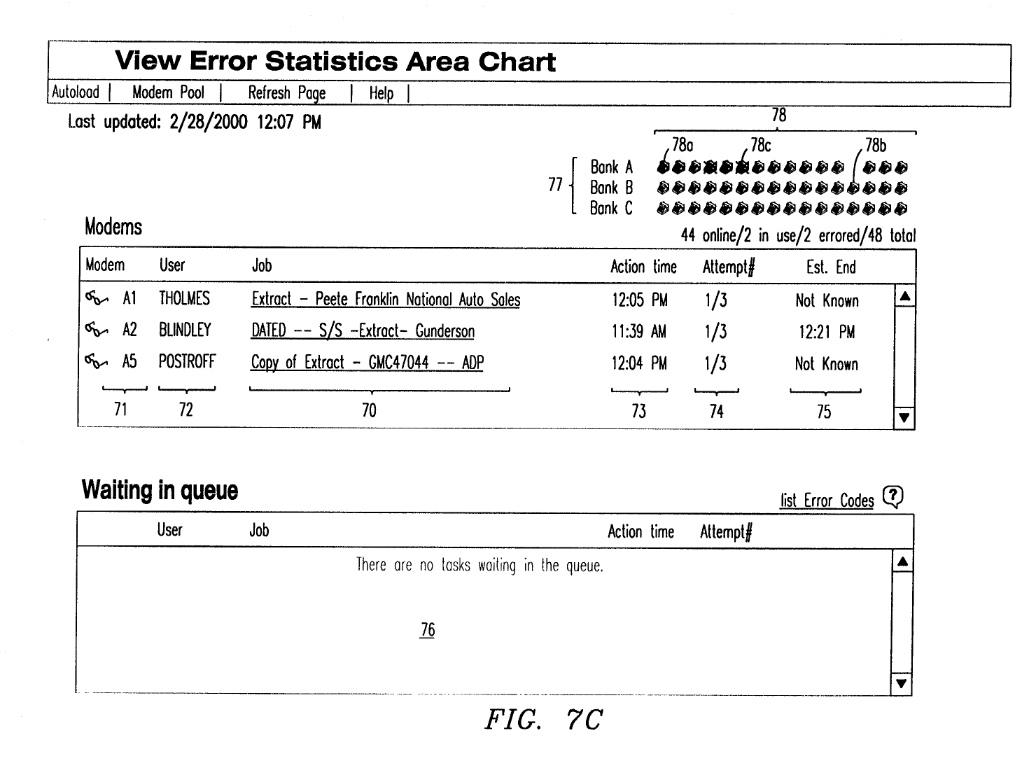

An exemplary screen shot of a partial display of the configuration module 61 is shown in FIG. 7A. As can be seen, the screen shot shows a partial list of the communication devices of a communication device pool called “Edison” along with their modem number, device ID, initialization string, baud rate, and current status. An “On-line” status indicates the communication device is enabled; “Off-line” means the communication device has been taken off-line; “Error” indicates the communication device has experienced a failure; and “Interactive” means the data access job running on the communication device is being manually controlled by a user.

The scheduling module 62 has primary responsibility for ordering the data access jobs in the queues and assigning the data access jobs to the available communication devices. As each one of the communication devices become available (e.g., by completing its assigned job), data access jobs not yet assigned are immediately assigned thereto. Under such an arrangement, the idle time of the communication devices are substantially reduced or eliminated, thereby maximizing the usage efficiency of the communication devices. Moreover, new data access jobs may simply be placed in the queue and executed in due course without the need for additional communication devices.

The ordering of the data access jobs in the queues is based upon one or more ordering factors including the time zone in which a particular vendor is located, the geographical location of the vendor, the amount of data traffic on the vendor system, a prearranged agreement with the vendor, the success of the previous data access jobs, the amount of data to be extracted, a number of other suitable factors. Modifications or alterations of the queues may also be made by operation of the scheduling module 62. For example, in some embodiments, unsuccessful data access jobs may be automatically rescheduled by the scheduling module 62. Such an arrangement reduces the delay in executing a data access job due to, for example, a problem with the communication device assigned thereto. Depending on the reasons for the failure, however, a job may be set aside instead until the underlying problems (e.g., the vendor system is down) are corrected.

The data logging module 63 operates to record the progress of one or more of the data access job from the beginning of the job to the conclusion. In a preferred embodiment, the progress of every data access job is recorded by the data logging module 63. The type of information recorded by the data logging module 63 includes the name of the particular data access job, which communication device was assigned, the start time, whether the job was completed successfully, the reason for a failure, and the end time of the job. This information is provided by the local control units to the system control unit which subsequently stores the information in a log file by operation of the data logging module 63. The information may thereafter be accessed by the user for review and analysis as needed.

The error analysis module 64 takes the failure data provided by the local control units and statistically compiles the data. A user may then review the compiled data to determine if there are any trends in the failure data. For example, if a high number of failures are observed during a particular time of day over a predetermined number of days, the user may determine that the vendor systems are busy or experiencing a high amount of data traffic during that part of the day. As a result of this analysis, the scheduled time for the job may be changed as needed.

In a preferred embodiment, if job failures are indicated as being due to a malfunction in a particular communication device, the error analysis module 64 assigns a predetermined score to the failing communication device based on the failure mode (e.g., lost connection, no dial tone, etc.) thereof. The number of errors experienced by a particular communication device as recorded by the data logging module 63 can be seen in the exemplary screen shot shown in FIG. 7A. Also, the “Error Level” shown in FIG. 7A is an indication of the current score of the communication device.

Once a communication device attains a certain threshold score indicative of a high level of communication device errors, the error analysis module 64 may temporarily take the communication device off-line in hopes that a cooling off period will enable the device to recover. In a preferred embodiment, when a device is taken off-line for a cooling off period, the device is also cleared and reset, via software control, to its system default state. Experimentation has determined that clearing and resetting the device clears most of the malfunctions in the modems and network connections. No data access jobs are assigned to the particular communication device until it is brought back on-line. Such an arrangement prevents a communication device which has a high failure rate from being assigned a data access job, thereby delaying execution of the data access jobs.

If the data communication device continues to experience failures after being brought back on-line such that a second threshold score is reached, the error analysis module 64 may permanently remove the communication device from the communication device pool. The first and second threshold scores may be selectively set to suit the needs of a particular application. Moreover, in some embodiments, multiple threshold scores may be selectively set, with each threshold score representing an incrementally longer temporary off-line time. Alternatively, a user such as a system administrator may manually take the device off-line upon seeing that the device has a high failure rate.

An exemplary list of the different types of failure modes has been provided in Table 1 below for convenient reference. The table includes a short description of the failure modes and the error codes assigned thereto. Also specified are which failure mode requires a data access job to be canceled, that is, removed from the queue, and which jobs may be rescheduled at a later time in accordance with the recommended delay period.

TABLE 1

| | | | Reschedule | |
|---|---|---|---|---|
| Code | Description | Cancel | Delay | |
| 0 | Script completed successfully | | | |
| 1 | Expect: TCL Error | | 5 | min. |
| 2 | Unable to initialize modem | | 5 | min. |
| 3 | No dial tone | | 5 | min. |
| 4 | No answer | | 45 | min. |
| 5 | Number busy | | 45 | min. |
| 6 | Connection timeout | | 30 | min. |
| 7 | Unable to access modem | | 5 | min. |
| 21 | Unable to find login prompt | | 5 | min. |
| 22 | Unable to get account prompt | | 5 | min. |
| 23 | Unable to login to firewall | | 5 | min. |
| 24 | Unable to login to host | | 5 | min. |
| 25 | Unable to find password prompt | | 5 | min. |
| 26 | Error obtaining path list. Lists are not | Yes | | |
| | the same length | | | |
| 31 | Capture path does not exist | Yes | | |
| 41 | Lost connection | | 5 | min. |
| 42 | Invalid timeout | | 10 | min. |
| 43 | Inactivity timeout | | 10 | min. |
| 44 | Time limit exceeded | Yes | | |
| 51 | Check files failed | Yes | | |
| 61 | Backup mode | | 1 | hour |
| 62 | Invalid password | Yes | | |
| 63 | Resize mode | | 1 | hour |
| 64 | A new password was required | Yes | | |
| 81 | Currently waiting in queue | | | |
| 82 | Currently running | | | |
| 83 | Currently waiting for debug process | | | |
| 84 | Removed from the queue | Yes | | |
| 85 | Dial task was already queued | Yes | | |
| 86 | Canceled due to questionable modem lock | | 5 | min. |
| 101 | Dial was run in debug mode. Result is | Yes | | |
| | unknown | | | |
| 102 | Canceled from interactive mode | Yes | | |
| 103 | Unable to locate interactive mode | Yes | | |
| | application | | | |
| 104 | Unable to parse command-line parameters | Yes | | |
| | for interactive mode | | | |
| 105 | User took manual control of job | | | |
| 106 | Unable to parse query for report | Yes | | |
| 107 | Script completed successfully with | Yes | | |
| | warnings | | | |

An exemplary screen shot of failure data that was statistically compiled and charted by the error analysis module 64 is shown in FIG. 7B. As can be seen, within a 24-hour period, a number failure modes from the list of failure modes in Table 1 have been charted in the screen shot in FIG. 7B. Although only 15 specific failure modes have been charted, the invention is not limited thereto and those of ordinary skill in the art will understand that a lesser or greater number of failure modes may be selected.

Brief definitions of the failure codes are now provided. “Script completed successfully” indicates a data access job was successfully completed. As can be seen, successfully completed scripts represent the majority of the data access jobs executed during this time period. “Backup/Resize mode” indicates that the vendor system did not allow access thereto because it was occupied with system backups or other similar tasks. This failure mode is not due to a malfunction in the communication device and, therefore, no score should be assessed to the specific communication device. Rather, in a preferred embodiment, the scheduling module 62 would recognize the nature of the failure from the failure mode and would reschedule the data access job for a later time when the vendor system is possibly available.

Another type of failure that is not due to a communication device error is the “Canceled from interactive mode” which indicates a user manually canceled the data access job. Because this data access job was canceled by the user, the scheduling module 62 preferably would not automatically reschedule this job.

One failure mode that is clearly due to a malfunction in the communication device is the “Modem error” failure mode. Upon experiencing this type of failure, the error analysis module 64 assesses a predetermined score associated with the failure mode against the communication device.

As for the remaining failure modes, “Capture path does not exist” indicates that the specified path (e.g., in the script file) for capturing the data from the vendor system did not exist.

“Check files failed” indicates the amount of data that was captured during a particular job is outside of the expected range.

“Could not connect” indicates the communication device could not make a connection with the vendor system. This failure can occur, for example, when there is no answer at the vendor system during a dial-in or a connection via the Internet could not be established.

“Currently waiting in queue” indicates someone tried to manually run a data access job that is already waiting in the queue.

“Error obtaining path list” indicates a failure that is due to some unknown error in the software of the vendor system.

“Invalid/Change password” indicates either the password used is invalid or it is time to change the current password.

“Removed from queue” indicates a pending data access job was manually removed from the queue by a user.

“Timeout error” indicates an expected response from the vendor system did not occur in the allotted time period.

“Unable to find prompt” indicates an expected prompt (e.g., a login prompt) from the vendor system could not be found.

“Unable to parse query for report” indicates a customized report designed to obtain specific data from a specific vendor system could not be run on that system.

“User took manual control of job” indicates a user manually took control of a data access job.

The progress of each data access job may be observed and monitored by the user through operation of the status monitor module 65. The status monitor module 65 obtains data regarding the status of each data access job in the queues and outputs this information on the display unit of the server.

An exemplary screen shot of the information displayed by the status monitor module 65 is shown in FIG. 7C for data access jobs running on the communication devices of the communication device pool called “Edison.” As can be seen, the screen shot shows a list of the data access jobs 70 currently active, the communication devices 71 assigned thereto, the users 72 (if any) currently exercising manual control of the jobs, the estimated start time 73 of the jobs, the number of attempts 74 that have been made to execute the jobs, and the estimated ending time 75 of the jobs. Any data access jobs currently awaiting a communication device assignment would be shown in the “Waiting in Queue” section 76.

The screen shot of FIG. 7C also includes an indication of how many communication devices are associated with the

“Edison” communication device pool along with their activity statuses. For example, the screen shot shows that there are three banks 77, Banks A-C, of communication devices, represented by the little telephone icons 78. There are a total of forty-eight communication icons. The darkened icon 78a indicates that a particular communication device is current active or in use, while the lighter icon 78b indicates the communication device is currently inactive. The icon 78c having an “X” mark thereon indicates the communication device malfunctioned during execution of a data access job. Thus, by viewing the screen shot, a user can quickly surmise the statuses of the various communication devices associated with a communication device pool as well as the progress of the data access jobs assigned thereto.

Finally, the manual control module 66 allows a user to manually control a data access job from the system control unit over the Internet. The manual control module 66 operates to let a user takeover a data access job once a connection (e.g., dial-in, virtual net, etc., using Telnet, FTP, Kermit, etc.) between the communication device and the vendor system has been established. Manual control of the data access job is useful, for example, when a vendor system user ID and/or password is needed to be changed. Additionally, customized reports prepared by the user for extracting certain specific data from the vendor system may be run under manual control. Oftentimes, resolution of a particular failure mode can be expedited by a user manually controlling the system.

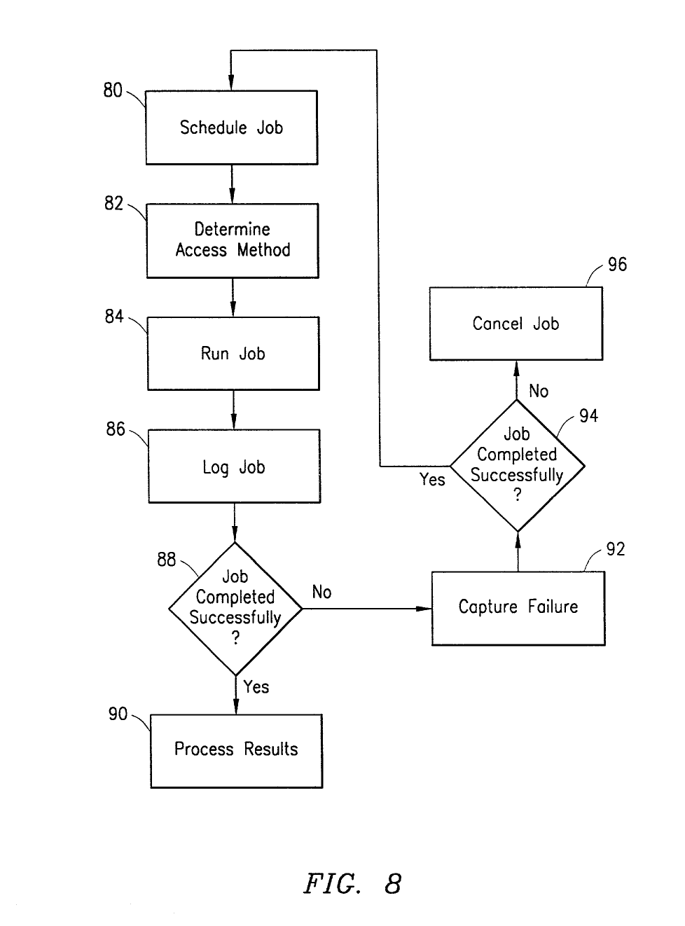

FIG. 8 illustrates an exemplary method of managing a batch access system according to an embodiment of the present invention. At step 80, a data access job is scheduled including placing the job within a queue and assigning a communication device of one of the local control units to execute the job. Next, the particular access method for the data job is determined, e.g., by direct dial-in or via a virtual net using Telnet, FTP, Kermit, or some other suitable access protocol at step 82. At step 84, the data access job is executed by the assigned communication device according to its position in the queue. The progress of the data access job is then logged and stored at step 86. A determination is made at step 88 to determine whether the job was successfully completed. If yes, the data extracted from the vendor system is processed and stored for transferring, for example, to a searchable on-line database. If the job was not completed successfully, then at step 92, the particular failure mode is captured and statistically compiled in order to facilitate the determination of any failure trends. At step 94, a determination is made as to whether the job should be rescheduled based on the failure mode. If yes, then step 80 is repeated to reschedule the job in the queue and another communication device thereto. If no, then the job is canceled at step 96.

Under such a batch access management method and system as described in the foregoing, both the success rate of the data access jobs and the usage efficiency of the communication devices may be optimized.

Although several embodiments of the method and system of the present invention have been illustrated in the accompanying drawings and described in the foregoing detailed description, it should be understood that the invention is not limited to the embodiments disclosed, but is capable of numerous rearrangements, modifications, and substitutions without departing from the spirit of the invention as set forth and defined by the following claims.

What is claimed is:

1. A method of managing a plurality of communication devices, said communication device being adapted to be cleared and reset to a default state if a communication failure occurs a predetermined number of times, said method comprising the steps of:
forming a queue of data access jobs to be run on said plurality of communication devices;
executing said data access jobs in accordance with said queue; and
controlling said queue in order to optimize a usage efficiency of said plurality of communication devices.

2. The method according to claim 1, wherein the step of controlling said queue is accomplished over the Internet.

3. The method according to claim 1, wherein controlling said queue includes rescheduling unsuccessful data access jobs in said queue.

4. The method according to claim 3, further comprising the step of compiling failure data for said unsuccessful data access jobs.

5. The method according to claim 4, further comprising the step of assigning a score to one or more of said plurality of communication devices based on said compiled failure data.

6. The method according to claim 5, further comprising the step of temporarily taking off-line each one of said plurality of communication devices scoring higher than a first predetermined score.

7. The method according to claim 5, further comprising the step of permanently taking off-line each one of said plurality of communication devices scoring higher than a second predetermined score.

8. The method according to claim 1, further comprising the step of logging a progress of one or more of said data access jobs.

9. The method according to claim 1, further comprising the step of allowing manual control of said data access job via an Internet based device.

10. The method according to claim 1, wherein said plurality of communication devices includes a modem.

11. The method according to claim 1, wherein said plurality of communication devices includes a network interface card.

12. A system for managing a plurality of data access jobs, comprising:
a plurality of communication devices for performing said plurality of data access jobs;
a local control unit coupled to and configured to operate said plurality of communication devices in accordance with a queue; and
a system control unit in communication with said local control unit and configured to control said queue in order to optimize a success rate of said data access jobs.

13. The system according to claim 12, wherein said system control unit communicates with said local control unit via an Internet connection.

14. The system according to claim 12, wherein said system control unit controls said queue by rescheduling unsuccessful data access jobs in said queue.

15. The system according to claim 12, wherein said system control unit is further configured to compile failure data for unsuccessful data access jobs.

16. The system according to claim 15, wherein said system control unit is further configured to assign a score to one or more of said plurality of communication devices based on said compiled failure data.

17. The system according to claim 16, wherein said system control unit is further configured to temporarily take off-line any one of said plurality of communication devices scoring higher than a predetermined score.

18. The system according to claim 16, wherein said system control unit is further configured to take off-line any one of said plurality of communication devices scoring higher than a predetermined score, said system control unit adapted to reset or clear any one of said plurality of communication devices scoring higher tat a predetermined score.

19. The system according to claim 12, wherein said system control unit is further configured to log a progress of one or more of said data access jobs.

20. The system according to claim 12, wherein manual control of a data access job can be accomplished over the Internet via said system control unit.

21. The system according to claim 12, wherein said plurality of communication devices includes at least one of a modem and a network interface card.

22. A method of managing a plurality of communication devices via a control system, comprising the steps of:
forming a queue of data access jobs to be run on said plurality of communication devices;
executing said data access jobs in accordance with said queue;
controlling said queue in order to optimize a success rate of said data access jobs wherein said control of said queue is accomplished over the Internet;
compiling failure data for unsuccessful data access jobs and assigning a score to one or more of said plurality of communication devices based on said failure data;
taking off-line any one of said plurality of communication devices scoring higher than a predetermined score;
resetting any one of said plurality of communication devices scoring higher than a predetermined score;
logging a progress of one or more of said data access jobs; and
allowing manual control of a data access job via an Internet connection.
